(19) United States
(12) Patent Application Publication
(10) Pub. No.: US 2012/0124068 A1
(43) Pub. Date: May 17, 2012

(54) DOCUMENT MANAGEMENT APPARATUS AND METHOD FOR CONTROLLING SAME

(75) Inventor: Masaki Toyama, Kawasaki-shi (JP)

(73) Assignee: CANON KABUSHIKI KAISHA, Tokyo (JP)

(21) Appl. No.: 13/284,749

(22) Filed: Oct. 28, 2011

(30) Foreign Application Priority Data
Nov. 12, 2010 (JP) 2010-253535

(51) Int. Cl. G06F 17/30

(52) U.S. Cl. 707/758; 707/E17.008

(57) ABSTRACT

A document management apparatus displays a plurality of attribute information related to an electronic document selected by a user on a display screen and determines whether attribute information dragged from the plurality of attribute information displayed on the display screen has been dropped into any of the plurality of storage units displayed on the display screen. When it is determined that a drag and drop operation has been executed, searching is executed in relation to the plurality of electronic documents stored in the storage unit associated with the drop destination for an electronic document having the attribute corresponding to the dragged attribute information.

### BACKGROUND OF THE INVENTION

1. Field of the Invention

The present invention relates to a document management apparatus and a method for controlling the same.

2. Description of the Related Art

A document management apparatus has been proposed that includes a function of using the selection of a keyword or a direct input from a keyboard to designate a specific domain in an electronic document storage unit that is divided into a plurality of units, and of searching in that domain for a document that matches a condition. The document storage unit includes a structure using a document storage unit, and for example, is termed a folder. Japanese Patent Laid-Open No. 2009-277191 discloses a contents management apparatus that sorts images by moving images displayed in a sorting source domain into a sorting destination domain using a drag and drop method.

However, a conventional document management apparatus must execute designation of the search conditions or designation of the electronic document storage unit that is the object of searching by direct input from a keyboard or by selection input by a keyword. Consequently, almost all designation of a search condition or an electronic document storage unit by a conventional document management apparatus is a designation by input of character string information, and therefore is troublesome for a user. Furthermore, input errors in relation to the character string information result in the possibility of not obtaining the search result expected by the user.

The contents management apparatus disclosed in Japanese Patent Laid-Open No. 2009-277191 is an apparatus that executes a sorting operation in relation to a plurality of images that are already displayed on a display screen, and does not have the object of searching an electronic document storage unit for an electronic document. Consequently, a document management apparatus has not been proposed that searches an electronic storage unit for an electronic document corresponding to defined attribute information using a directly intuitive operation by a user and without reliance on input of character string information.

### SUMMARY OF THE INVENTION

A document management apparatus of the present invention searches an electronic document storage unit for an electronic document corresponding to attribute information in accordance with a directly intuitive operation by a user.

The document management apparatus of an aspect of the present invention includes a display unit configured to display a plurality of storage units configured to store a plurality of electronic documents and a plurality of attribute information related to an electronic document selected by a user on a display screen, a determination unit configured to determine whether a drag and drop operation has been executed in which attribute information that has been dragged from the plurality of attribute information displayed on the display screen has been dropped into any of the plurality of storage units displayed on the display screen, a search unit configured to search the plurality of electronic documents stored in the storage unit associated with the drop destination for an electronic document having the attribute corresponding to the dragged attribute information when the determination unit determines that a drag and drop operation has been executed, and an output unit configured to output information related to the electronic documents searched by the search unit as a search result.

Further features of the present invention will become apparent from the following description of exemplary embodiments with reference to the attached drawings.

### BRIEF DESCRIPTION OF THE DRAWINGS

FIG. 1 illustrates a system configuration example according to the present exemplary embodiment.

FIG. 2 illustrates a hardware configuration example of a client PC.

FIG. 3 is an example of a block diagram of the functions of a client PC.

FIG. 4 illustrates a display example of an operation screen.

FIG. 5 illustrates another display example of an operation screen.

FIG. 6 describes an operation example on the operation screen.

FIG. 7 is a flowchart describing a document searching process according to the document management apparatus in a first exemplary embodiment.

FIG. 8 illustrates a display example of search results.

FIG. 9 describes an operation example on the operation screen according to a second exemplary embodiment.

FIG. 10 is a flowchart describing a document searching process according to the document management apparatus in a third exemplary embodiment.

### BRIEF DESCRIPTION OF THE DRAWINGS

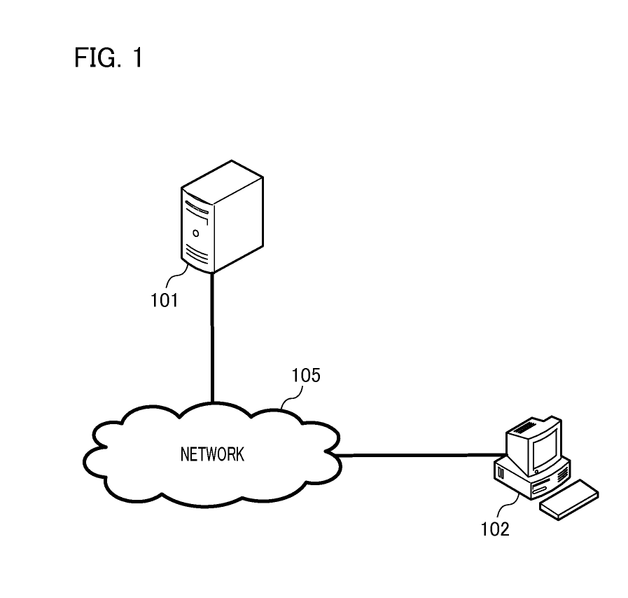

FIG. 1 illustrates a system configuration example according to the present exemplary embodiment. The system illustrated in FIG. 1 includes a document management server 101 and a client PC 102. The document management server 101 and the client PC (personal computer) 102 are connected to enable communication via a network 105. The network 105 for example is the Internet, an intranet, or the like. Although FIG. 1 illustrates a single client PC 102 connected to the network 105, the system according to the present exemplary embodiment may be provided with a plurality of client PCs 102.

The document management server 101 provides general document management services including document storage, searching and the like. The document management server 101 includes a document management database. The client PC 102 is the document management apparatus according to the present embodiment. The document management server 101 and the client PC 102 may be adapted to function as a single document management apparatus.

The client PC 102 includes a document management client configured to use a document management service provided by the document management server 101. The document management client operates on the client PC 102. The document management client for example is an application operated on various types of operating systems such as Microsoft Windows (Registered Trademark) or Linux (Registered Trademark), or the like. The document management client may be an application operated on a Web browser provided on the client PC 102.

When the network 105 is the Internet, the document management server 101 may function as a cloud service. The configuration of the system when the document management server 101 is a cloud service is the same as a general cloud service configuration.

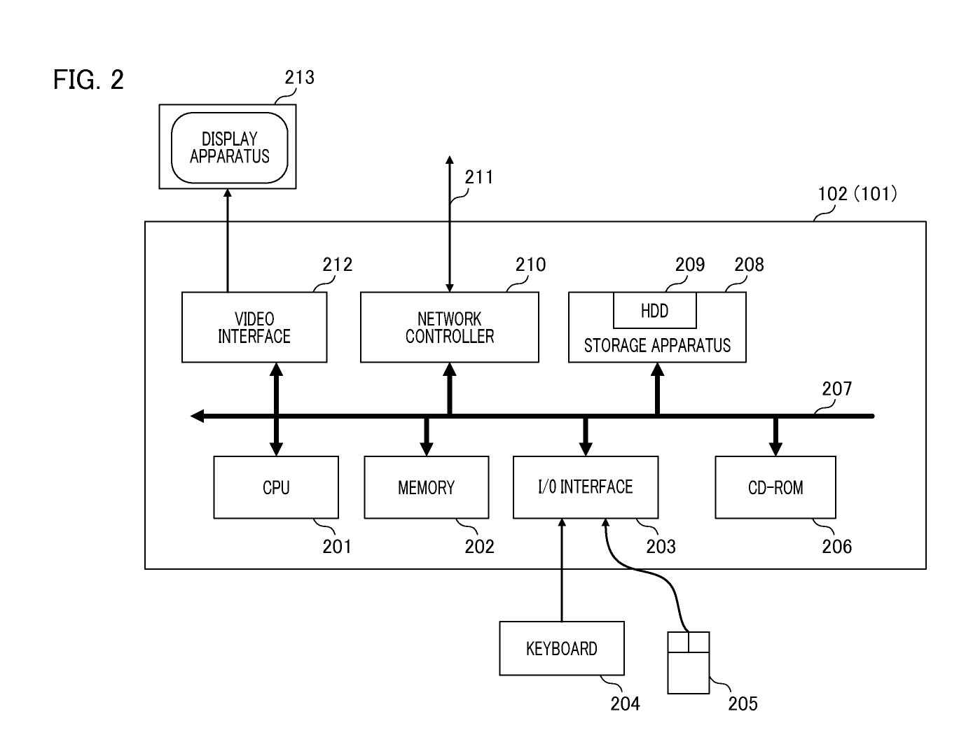

FIG. 2 illustrates a hardware configuration example of the client PC illustrated in FIG. 1. The hardware configuration example of the document management server 101 is the same as the hardware configuration example of the client PC 102 illustrated in FIG. 2.

The client PC 102 is connected with an input apparatus such as a pointing device including a keyboard 204, a mouse 205 or the like, and an output apparatus such as a display apparatus 213 or the like. The network controller (NC) 210 is connected to the network 105 via a predetermined network interface 211, and executes communication control processing with other network devices. A CPU 201 controls the overall client PC 102. The CPU 201 includes at least one processor.

A memory 202 stores computer programs (control programs) used in control of the client PC 102 by the CPU 201. The memory 202 is a random access memory (RAM) or a read only memory (ROM). The video interface 212 outputs images to a display apparatus 213.

The I/O interface 203 receives input information inputted in accordance with an operation of the keyboard 204 or the mouse 205. The storage apparatus 208 includes a hard-disk drive (HDD) 209. The HDD 209 stores data being the object of processing by the client PC 102 (for example, document files or image data). The HDD 209 may be configured to store control programs used in control of the client PC 102 by the CPU 201. The storage apparatus 208 may be configured to include a silicone drive.

A CD-ROM drive 206 is used as a non-volatile data source. An interconnect bus 207 mediates communication between each processing unit provided in the client PC 102. More specifically, the interconnect bus 207 mediates communication between each processing unit in a configuration according to an operating system such as Microsoft Windows (Registered Trademark), Linux (Registered Trademark), or the like that operate on the client PC 102 based on instructions from the CPU 201.

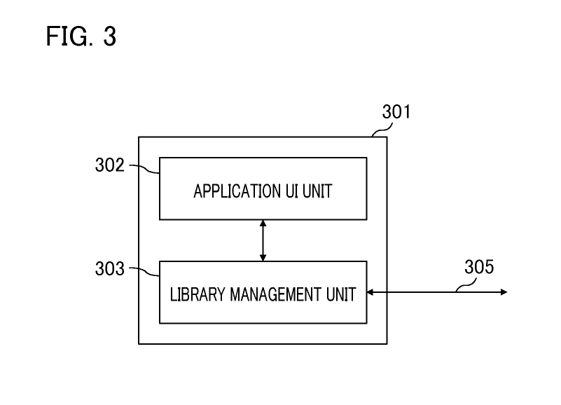

FIG. 3 is an example of a block diagram of the functions of a client PC. The functions of the client PC 102 illustrated in FIG. 3 are realized by the application 301 provided in the document management client operated on the client PC 102.

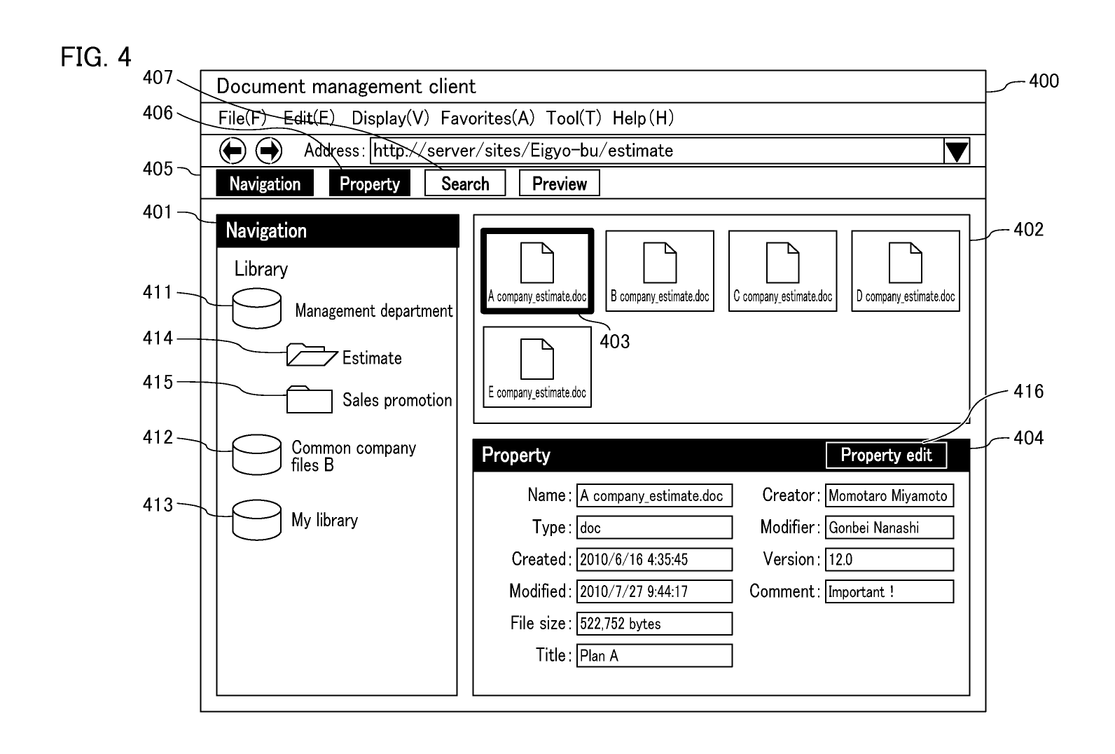

The application 301 includes an application UI unit 302 and a library management unit 303. The application UI unit 302 functions as a display unit configured to constitute and display an operation screen (application UI) as described below with reference to FIG. 4. The application UI unit 302 executes display processing of the processing result of an input operation upon receipt of various types of input operation from a user. For example, the application UI unit 302 receives a request for a document operation in accordance with an operation of the keyboard 204 or the mouse 205 by a user on the screen of the display apparatus 213, and executes a function processing in response to the request for the document operation. The request for the document operation is for example a search request for a document file.

The library management unit 303 manages the library used in processing of document management by the application 301. The library management unit 303 executes various types of document operations including perusal, updating, attribute variation, searching and the like of documents in the library, or storage of documents in the library.

The library is a data storage unit configured to store data for document management. For example, the library stores document data (document files) and document attributes. Two types of configurations are present in the library used by the application 201 depending on the data storage location. The first is a local library configuration in which the application 301 prepares a data storage domain in the local HCC 209 and the application 301 itself manages the data in that data storage domain. When the library is configured as a local library, the system according to the present embodiment includes a configuration in which the document management server 101 is omitted and only the document management client 102 is provided.

The second is a common library configuration in which the application 301 delegates document management to a document management service provided by the document management server 101. In the common library configuration, the library management unit 303 transfer the request for a document operation received from the application UI unit 302 to a document management server 101. Then the library management unit 303 receives the processing result corresponding to the document operation request from the document management server 101 and transfers same to the application UI unit 302.

When the library is in a common library configuration, the library management unit 303 may be configured to enable sending/receiving of data between the application 301 and the document management service of the document management service 101. Therefore, when the document management client is configured for operation on a Web browser, the common library configuration is the optimal configuration. The interface 305 is an interface that connects the library management unit 303 with the local library that is constituted in the storage apparatus 208. The interface 305 may be an interface that connects the library management unit 303 with the document management service of the document management server.

FIG. 4 illustrates a display example of an operation screen. The application UI unit 302 displays an operation screen 400 as an application UI. The navigation pane 401 in FIG. 4 is a display domain displaying a library recorded by the application and a folder disposed under the library. The library and the folder are a plurality of storage units (electronic document storage units) that stores a plurality of electronic documents. The electronic document for example is a document file. The domain on an icon indicating respective libraries and folders in the navigation pane 401 is a domain (first domain) that indicates the respective libraries or folders.

A user can select a library or a folder displayed on the navigation screen 401 by use of a pointing device such as a mouse or the like. The display example of the operation screen illustrated in FIG. 4 displays the libraries 411 to 413, and the folders 414 and 415. Furthermore, the folder 414 is selected.

The file list pane 402 is a display domain that displays a document stored in the library or the folder that is current selected in the navigation pane 401. In other words, the file list pane 402 is a display domain that displays a plurality of electronic documents that are stored in the electronic document storage unit selected by the user from the electronic document storage units displayed in the navigation pane 401. When a folder is currently selected in the navigation pane 401, a document stored in the folder that is currently selected is displayed in the file list pane 402.

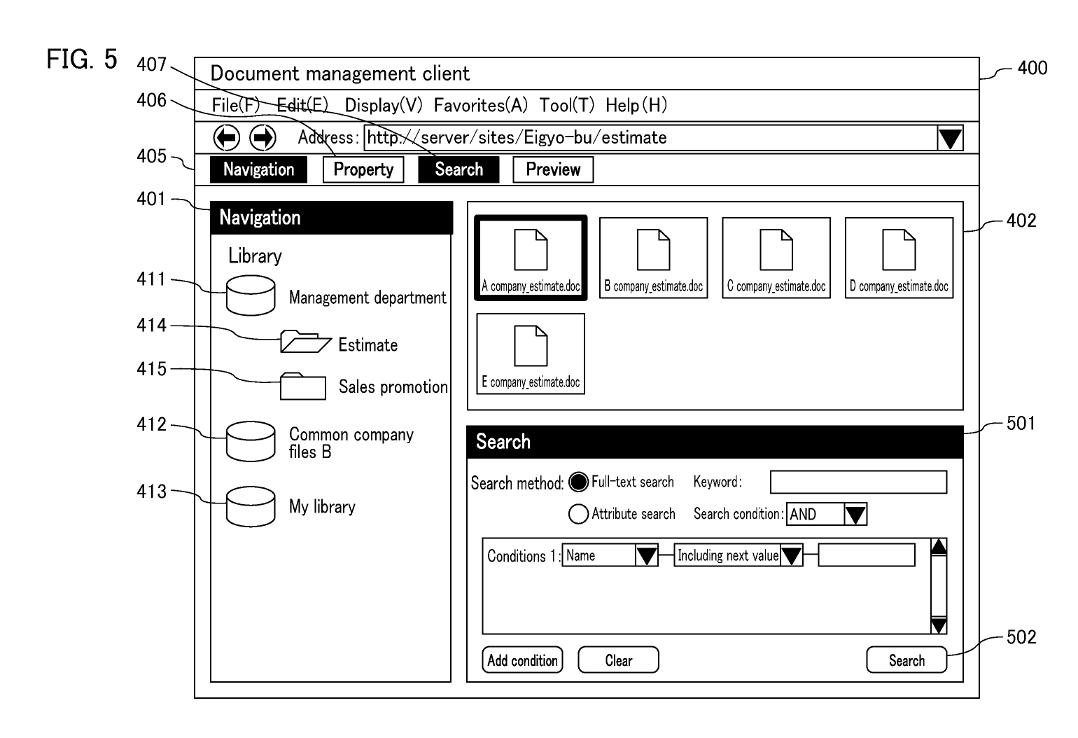

In the example illustrated in FIG. 4, five documents are selected in the file list pane 402. When the user selects a document in the file list pane 402 using a pointing device, the document is enclosed in a selection frame 403. In the example illustrated in FIG. 4, since the document having the file name (Acompany_estimate.doc) is enclosed in the selection frame 403, the document is selected. When a search is executed by depressing the search button 502 (refer to FIG. 5), the application UI unit 302 displays the search result on the file list pane 402. The search result is a list of documents or folders that matches the search conditions. In other words, (the application UI unit 302 of) the application 301 functions as an output unit configured to output the information related to the searched electronic documents as a search result.

The property pane 404 is a display domain configured to display a plurality of attribute information related to the electronic document selected by the user from the plurality of electronic documents displayed on the file list pane 402. Attribute information includes attribute items (for example, name, date of creation, file size and the like) and attribute item values (for example, Acompany_estimate.doc, 2010/6/16 14:35:45, 522, 752 bytes). The settable items are predefined in each library, and vary depending on the library function. For example, when the library is a local library as described above, items corresponding to the attributes that are the same as the attributes that can be set in a file system of an operating system can be set. Furthermore, for example, when the library is a common library as described above, items corresponding to the attributes that are the same as the attributes that are arbitrarily customized by a setting on the document management server 101 can be set.

The library management unit 303 has the function of managing the attribute items using the library, and transferring items and item values of attributes corresponding to a library to the application UI unit 302. The domain that encloses the respective attribute information in the property pane 404 (a combination of the attribute items and the attribute item values) is termed an attribute item domain (second domain).

An edit button 416 is a button enabling editing of attribute item values displayed in the property pane 404. When a user depresses the edit button 416, an attribute item value in the property pane 404 cannot be changed unless in an edit configuration.

The panel 405 is a panel configured to switch the display or non-display of respective panes in the operation screen. The button 406 is a button configured to switch the display or non-display of the property pane 404 upon depression thereof. Furthermore, the button 407 is a button configured to switch the display or non-display of the search pane 501 (refer to FIG. 5) upon depression thereof.

In the present exemplary embodiment, the property pane 404 and the search pane 501 are not displayed simultaneously. In other words, when the button 406 is in a depressed state, the button 407 is in a non-depressed state. Furthermore, when the button 407 is in a depressed state, the button 406 is in a non-depressed state. When the application 301 executes a document operation, the application UI unit 302 displays the property pane 404, and since the search pane 501 is displayed only when the application 301 executes a search operation, the document display domain can be displayed in a wide configuration.

The application UI unit 302 may be configured to display the property pane 404 and the search pane 501 simultaneously so that a user can execute settings with the search pane 501 while referring to the display on the property pane 404.

FIG. 5 illustrates another display example of a display screen. In the operation screen in FIG. 4, when a user depresses the button 407, the application UI unit 302 switches the operation screen to the operation screen illustrated in FIG. 5. More precisely, the application UI unit 302 displays the search pane 501.

The search pane 501 is an operation screen domain for setting the document search method and the conditions as search conditions. The search pane 501 includes the functions of an overall search and an attribute search. The overall search is a function in which a character string is used as a search condition to thereby search for text information that is included in a document that is stored in a designated electronic document storage unit (library or folder). The attribute search is a function in which a folder or a document that is stored in a designated electronic document storage unit is selected searched attribute information (for example, a combination of an attribute item and an attribute item value selected in the property pane 404 illustrated in FIG. 4).

The search button 502 is a button that executes a search upon depression thereof. The button 502 adopts a configuration in which the button can be depressed upon input of required conditions to commence a search process in the search pane 501. When the search button 502 is depressed, the application 301 executes a search according to the search conditions set in the search pane 501, and displays the search results on the file list pane 402.

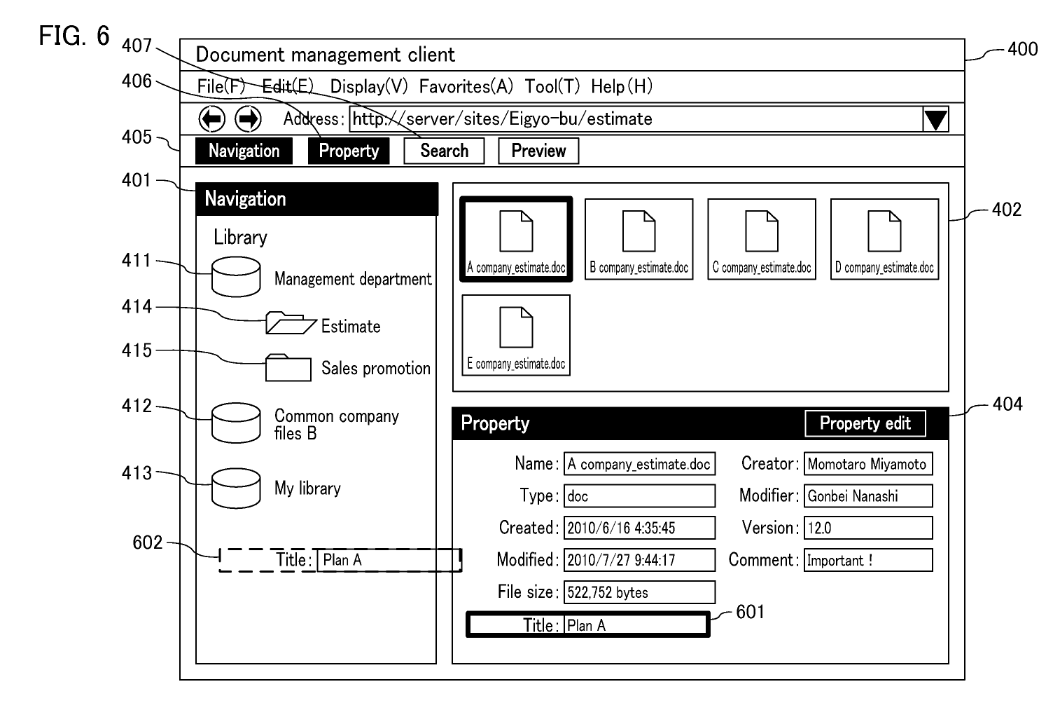

FIG. 6 describes an operation example on the operation screen. FIG. 6 illustrates an example of an operation of selecting an attribute item and attribute item values in the property pane 404. After a user uses a mouse 205 for example to move a cursor (for example, a mouse pointer) on a domain 601 (on the second domain) and then left clicks the mouse 205, when the domain 601 is dragged, the application 301 selects the domain 601. The application 301 selects the attribute information that indicates the domain 601. In this example, the domain 601 is an attribute information domain corresponding to a group of attribute items (title) and attribute item values (plan A). Therefore, the attribute items (title) and attribute item values (plan A) are selected as attribute information.

Then, a user moves the cursor into the navigation pane 401. The reference numeral 602 denotes an attribute information domain that is being dragged. Subsequently, when a user drops the cursor onto the library or the folder (onto the first domain) in the navigation pane 401, the application 301 selects the first domain corresponding to the drop position. Then, the application 301 selects the library or the folder corresponding to the first domain as the electronic document storage unit that is the object of an attribute search. In other words, the application 301 has the function of a selection unit configured to select the first domain and the second domain according to a cursor operation (drag/drop) on a display screen (on an operation screen).

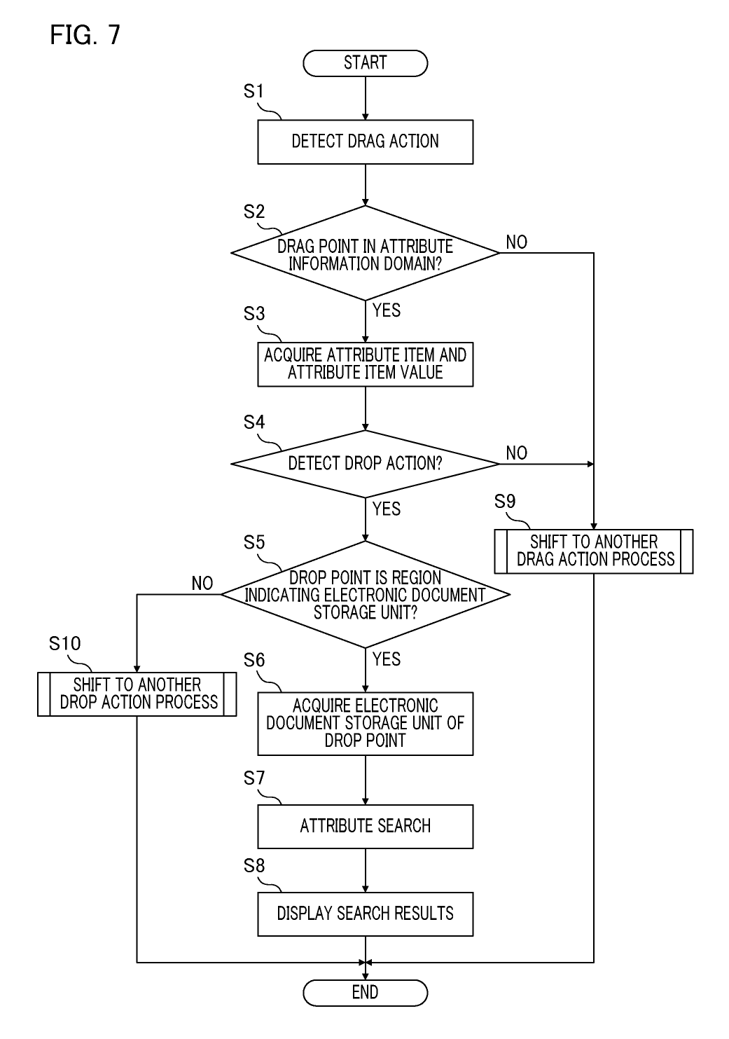

FIG. 7 is a flowchart describing a document searching process according to the document management apparatus in a first exemplary embodiment. Firstly, the application 301 searches for a drag action of the mouse 205 via the I/O interface 203 (step S1). Then the application 301 determines whether the dragging point, that is to say, the cursor position is in the attribute information domain of the property pane 404 (step S2).

When the point of dragging is not in the attribute information domain, the processing proceeds to step S9, and the application 301 executes predetermined other processing that is different from the document search processing (another dragging action process) (step S9). More precisely, the application 301 cancels the detected drag action.

When the dragging point is in the attribute information domain, the application 301 selects the attribute information domain (second domain) that is the point of dragging. Then the application 301 acquires the attribute information corresponding to the selected attribute information domain (attribute item and attribute item value) (step S3).

Next, the application 301 determines whether a drop action of the mouse 205 has been detected via the I/O interface 203 (step S4). When the application 301 does not detect a drop action of the mouse 205, the processing proceeds to step S9, and when the application 301 detects a drop action of the mouse 205, the processing proceeds to step S5.

In step S5, the application 301 determines whether the drop point is a domain (first domain) that indicates the electronic document storage unit (library or folder) in the navigation domain 401 (step S5).

In other words, the application 301 functions as a determination unit configured to determine whether a drag and drop operation has been executed in which attribute information that has been dragged from the plurality of attribute information displayed on the display screen has been dropped into any of the plurality of storage units displayed on the display screen.

When the drop point is not a domain indicating an electronic document storage unit in the navigation pane 401, the application 301 executes predetermined other processing that is different from the document search processing (another drop action process) (step S10). More precisely, the application 301 cancels the detected drop action. The application 301 may be configured to execute a popup display of all or a predetermined electronic document storage unit in a selectable configuration in the navigation pane 401.

When the drop point is the domain indicating the electronic document storage unit in the navigation pane 401, the application 301 selects the domain corresponding to the drop point and acquires the electronic document storage unit indicated by the domain (step S6). Next, the application 301 executes an attribute search using the attribute information acquired in step S3 and the electronic document storage unit acquired in step S6 (step S7).

In other words, the application 301 searches the electronic document storage units indicated by the first domain for electronic documents that have the attributes corresponding to the attribute information that indicates the second domain. That is to say, when it is determined that a drag and drop operation has been executed, the application 301 functions as a search unit configured to search the plurality of electronic documents stored in the electronic document storage units associated with the drop destination for electronic documents having an attribute corresponding to the dropped attribute information. More specifically, the application 301 searches for and acquires a folder or a document file corresponding to the attribute information acquired in step S3 from the electronic document storage units acquired in step S6 in accordance with predetermined search conditions. In this example, the application 301 executes an automatic attribute search in response to the drop action without executing an attribute search in response to a depression operation in relation to the search button 502 by a user. Thereafter, the application 301 displays the result of the attribute search in step S7 on the file list pane 402 (step S8).

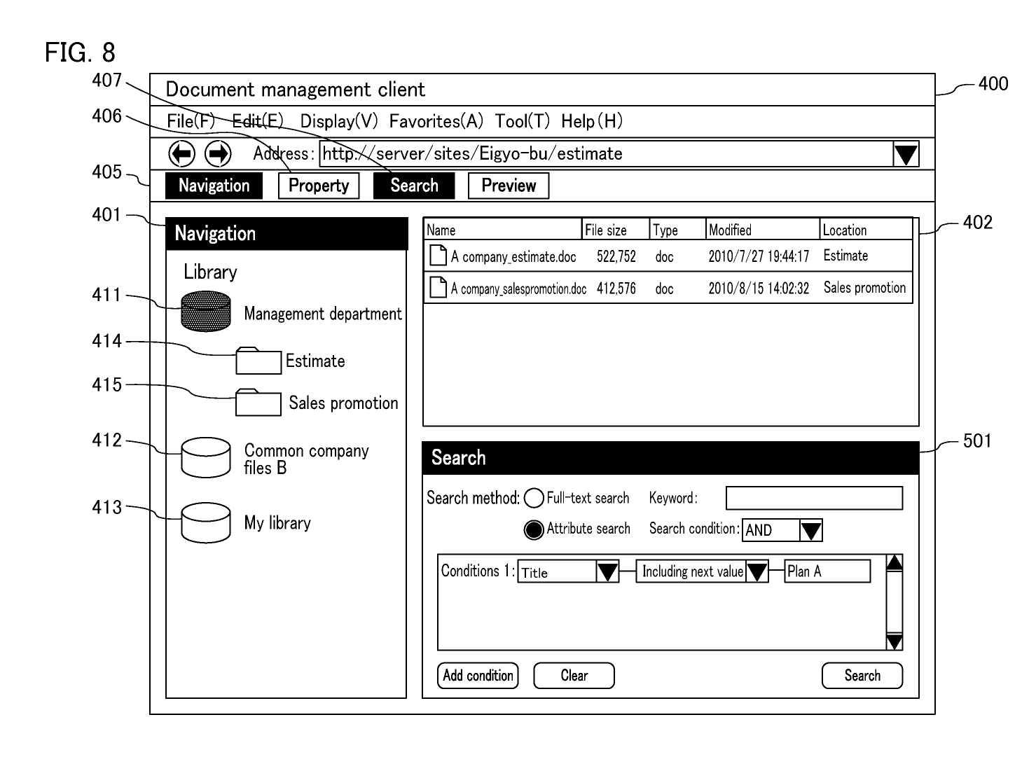

FIG. 8 illustrates a display example of search results. FIG. 8 illustrates a display example of the results of an attribute search when the drag point (step S2 in FIG. 7) is the domain 601 in FIG. 6 and the drop point (S5 in FIG. 7) is the library 411. The file list pane 402 illustrated in FIG. 8 shows search results including information related to the document file of the file name “Acompany_estimate.doc” and information related to the document file of the file name “Acompany_salespromotion.doc”.

The document management apparatus in exemplary embodiment 1 executes an attribute search of the drop destination storage location using a combination of attribute item and attribute item value as a result of a user dragging the attribute item and attribute item value with the mouse 205 and dropping same onto the electronic document storage unit on the navigation pane 401. Consequently, the document management apparatus in exemplary embodiment 1 enables searching of an electronic document storage unit for an electronic document corresponding to attribute information according to a directly intuitive operation by a user.

Next, a second exemplary embodiment will be described. The document management apparatus according to the second exemplary embodiment executes an attribute search using attribute information indicated by respective attribute information domains included in a plurality of attribute information domains selected by dragging.

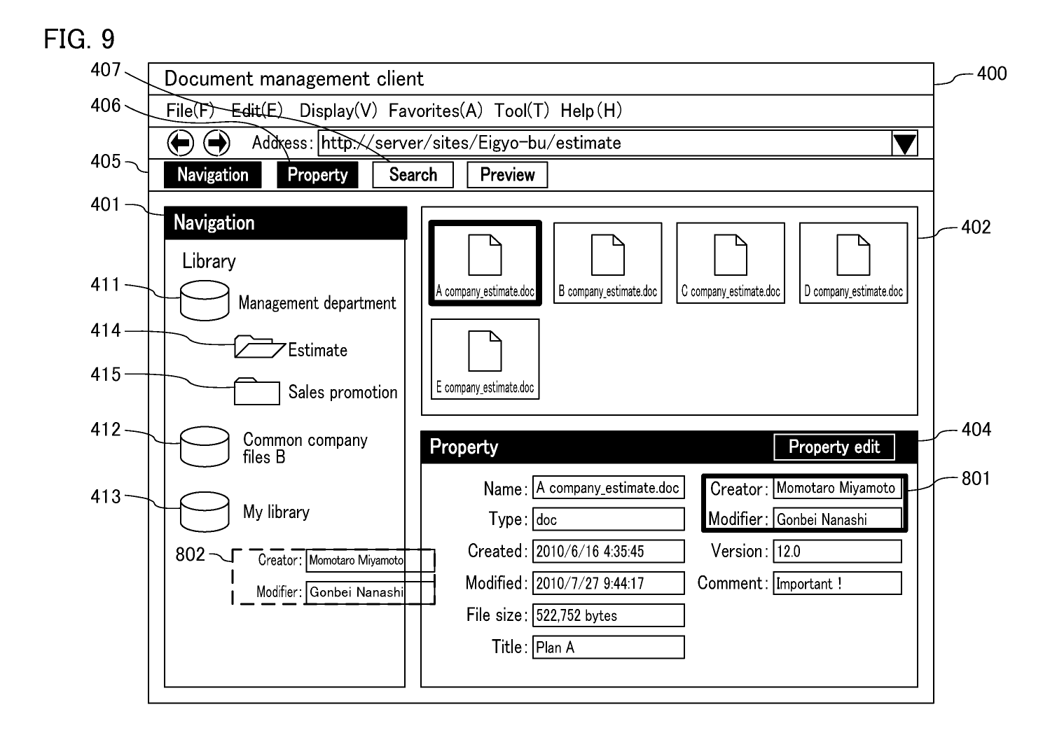

FIG. 9 describes an operation example on the operation screen according to the second exemplary embodiment. In the second exemplary embodiment, the application 301 selects a plurality of attribution items and an attribution item value corresponding to the respective attribution items by a cursor drag operation. In other words, the application 301 selects a plurality of attribution information domains.

For example, when the drag of the attribute information domain 801 illustrated in FIG. 9 is commenced, the application 301 selects two attribute information domains included in the attribute information domain 801. That is to say, the application 301 selects an attribute information domain indicating the attribution item “creator” and the attribute item value “Momotaro Miyamoto” and an attribute information domain indicating the attribution item “modifier” and the attribute item value “Gonbei Nanashi”. In this manner, attribute information including a plurality of attribution items and attribute item values is selected. The reference numeral 802 in FIG. 9 shows an attribution information domain that is dragged into the navigation pane 401. The number of the plurality of selectable attribution information domains may be a predetermined arbitrary number of at least 2.

The document searching process according to the document management apparatus in the second exemplary embodiment differs in relation to the following points from the document searching process according to the document management apparatus in the first exemplary embodiment described with reference to FIG. 7. In other words, the application 301 in the second exemplary embodiment in step S2 of FIG. 7 determines whether the plurality of selectable attribution information domains has been dragged by a cursor drag operation. For example, when the user drags the attribution information domain 801 including the two attribution information domains as illustrated in FIG. 9, the application 301 determines that the attribution information domain 801 has been dragged.

Furthermore, in step S3 in FIG. 7, the application 301 acquires the attribute information indicated by the respective attribution information domains that are included in the dragged attribution information domain. In this manner, the application 301 acquires information including a combination of a plurality of attribution items and corresponding attribution item values contained in the acquired attribution information.

Then, in step S7 in FIG. 7, the application 301 executes the following processing according to the predetermined search conditions. The application 301 uses the combination of information of a plurality of attribution items and corresponding attribution item values acquired in step S3 to execute an attribute search in relation to the electronic document storage unit acquired in step S6. An AND condition or an OR condition is preset as the search condition used in the attribute search.

For example, an example will be described in which the attribute information 801 in FIG. 9 is dropped onto the library 411 in the navigation pane 401. In the example, when the search condition is set to an AND condition, the application 301 executes the following attribute search on the library 411. The application 301 acquires a folder or a document file including the combination of the attribution item “creator” and the attribute item value “Momotaro Miyamoto” and the combination of the attribution item “modifier” and the attribute item value “Gonbei Nanashi”.

In the example, when the search condition is set to an OR condition, the application 301 executes the following attribute search on the library 411. The application 301 acquires a folder or a document file including the combination of the attribution item “creator” and the attribute item value “Momotaro Miyamoto”, or the combination of the attribution item “modifier” and the attribute item value “Gonbei Nanashi”.

In other words, in the second exemplary embodiment, the application 301 uses the attribute information indicated by the respective second domains included in a plurality of selected second domains to search for an electronic document in the electronic document storage units indicated by a selected first domain. In other words, when attribute information that is subject to a drag and drop operation is a plurality of types of attribute information, the application 301 searches for an electronic document from the plurality of electronic documents stored in the electronic document storage units associated with the drop destination based on the plurality of types of attribute information that is subject to a drag and drop operation.

According to the document management apparatus in the second exemplary embodiment, an attribute search in which a combination of a plurality of attribute items and attribute item values is subject to an AND search or an OR search can be executed according to a directly intuitive operation by a user.

Next, a third exemplary embodiment will be described. The combination of attribute items and attribute item values in an electronic document may be unique in the electronic document storage unit storing the electronic document. For example, in the property pane 404 illustrated in FIG. 4, the combination of attribute item “name” and attribute item value “Acomany_estimate.doc” is unique in the folder 414 selected in the navigation pane 401. That is to say, a document having the combination of attribute item and attribute item value is uniquely determined in the folder 414.

Consequently, the document management apparatus according to the third exemplary embodiment executes the following processing when the electronic document storage unit selected in the drop operation is an electronic document storage unit that stores the electronic document selected in the file list pane 402. In other words, the application 301 provided in the document management apparatus functions as a search limiting unit configured to limit the execution of an attribute search for an electronic document when the attribute information selected in the drag operation is unique information in the electronic document storage unit selected in the drop operation.

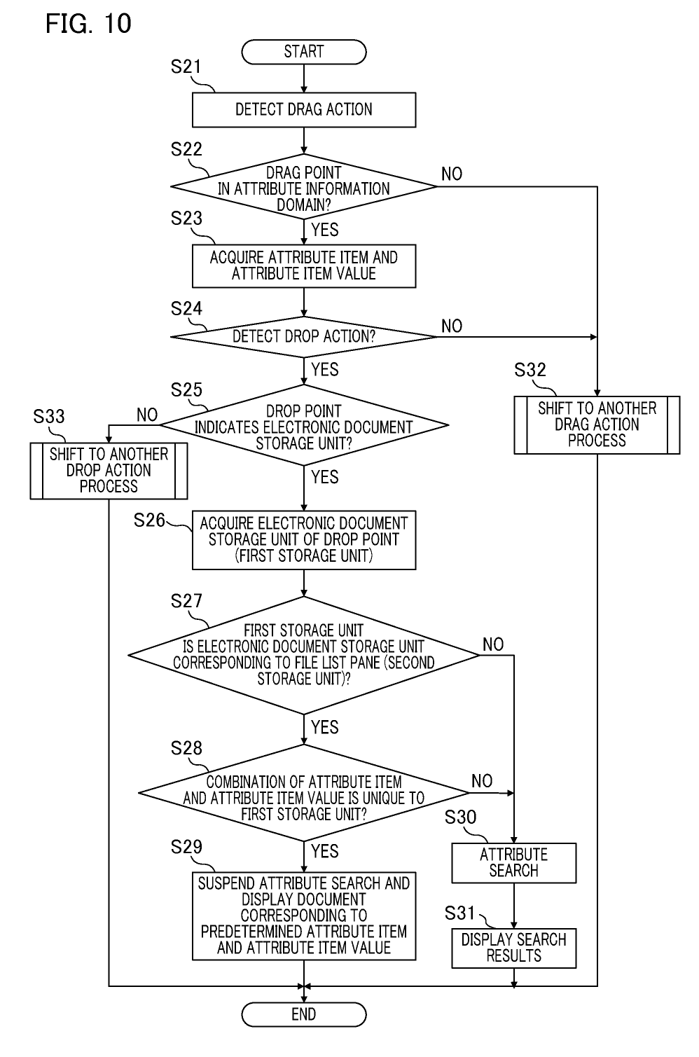

FIG. 10 is a flowchart describing a document searching process according to the document management apparatus in the third exemplary embodiment. The steps S21 to S26 in FIG. 10 are the same as steps S1 to S6 in FIG. 7. Furthermore, the steps S32 and S33 in FIG. 10 are the same as steps S9 and S10 in FIG. 7.

The premise of the processing illustrated in FIG. 10 is that the application UI unit 302 displays a domain (third domain) indicating the electronic document stored in the electronic document storage unit corresponding to the first domain on the operation screen. The third domain for example is the domain on each document displayed on the file list pane 402 in the operation screen in FIG. 4. Of the third domains displayed on the operation screen, the application UI unit 302 displays the domain indicating attribute information for the electronic document indicating the selected third domain on the operation screen as a second domain. In the example, the domain on the document termed “Acompany_estimate.doc” is selected from the third domains displayed on the file list pane 402 illustrated in FIG. 4. The application 301 stores the information in relation to the electronic document “Acompany_estimate.doc” indicating the selected third domain in the predetermined storage unit. Then the application UI unit 302 displays the attribute information domain indicating the attribute information for the selected document termed “Acompany_estimate.doc” in the property pane 404 in FIG. 4.

The application 301 determines whether the electronic document storage unit (first storage unit) acquired in the step S26 is an electronic document storage unit (second storage unit) corresponding to the file list pane 402 (step S27). In other words, the application 301 determines whether the electronic document storage unit indicated by a first domain selected by a drop is an electronic document storage unit that stores the electronic document corresponding to the third domain selected in the file list pane 402.

When the first storage unit is not the second storage unit, the processing proceeds to step S30. Then the application 301 executes an attribute search using the attribute information acquired in step S23 and the electronic document storage unit acquired in step S26 (step S30). Thereafter, the application 301 displays the results of the attribute search in the step S30 on the file list pane 402 (step S31).

When the first storage unit is the second storage unit, the application 301 determines whether the combination of the attribute item and the attribute item value acquired in step S23 is unique to the same electronic document storage unit (step S28). More specifically, the application 301 determines whether the combination of the attribute item and the attribute item value acquired in step S23 is unique to the first storage unit. When the combination of the attribute item and the attribute item value is not unique to the first storage unit, the processing proceeds to step S30.

When the combination of the attribute item and the attribute item value is unique to the first storage unit, the application 301 executes the following processing without executing an attribute search. In other words, the application 301 executes display in a predetermined display domain of information related to the electronic document corresponding to the combination of the attribute item and the attribute item value that is already displayed on the file list pane 402 (step S29).

For example, the folder 414 is displayed on the navigation pane 401 as a second storage unit on the operation screen illustrated in FIG. 4. The file list pane 402 in the operation screen illustrated in FIG. 4 is the display domain corresponding to the folder 414. The respective attribute items and the attribute item values displayed in the property pane 404 are attribute items and the attribute item values that have a document file “Acompany_estimate.doc” selected in the file list pane 402.

When a user drags the attribute information domain corresponding to the attribute information indicated as an attribute item “name” and an attribute item value “Acompany_estimate.doc”, and drops same onto the folder 414, the application 301 acquires the folder 414 as a first storage unit. Consequently, the application 301 determines that the first storage unit is the second storage unit (YES in step S27 in FIG. 10).

As described above, the combination of attribute item “name” and attribute item value “Acompany_estimate.doc” is only present once in the folder 414. Therefore, the application 301 determines that the combination of attribute item and attribute item value acquired in step S23 is unique in the first storage unit (YES in step S28). The application executes display on the operation screen of the predetermined document corresponding to the combination of attribute item and attribute item value, that is to say, the “Acompany_estimate.doc” document file, that is the document displayed in the file list pane 402 (step S29). More specifically, the application 301 acquires the electronic document “Acompany_estimate.doc”, that is stored in the storage unit when the third domain is selected, from the storage unit and displays same. In other words, the application 301 does not execute a search process on the electronic document when the electronic document storage unit associated with the drop destination is an electronic document storage unit that stores the electronic document that includes the dragged attribute information, and the attribute information subjected to a drag and drop is unique in the electronic document storage unit associated with the drop destination. The application 301 outputs information as a search result that indicates an electronic document corresponding to the third domain selected on the operation screen, that is to say, information that indicates an electronic document selected by a user corresponding to the plurality of attribute information displayed by the application 301 that functions as a display unit.

According to the operation illustrated in FIG. 10, the search execution is suppressed when the combination of the attribute item and the attribute item value is unique, and the correct search result is displayed on the file list pane 402. An effect of reducing the load on the document management server 101 or an effect of reducing the traffic on the network 105 can be expected.

Next, a fourth exemplary embodiment will be described. The application 301 provided in the document management apparatus according to the fourth embodiment determines search conditions that are conditions related to searching the electronic document storage unit indicating the selected first domain for an electronic document with reference to attribute information indicating the selected second domain. For example, when the selected attribute item value is in the form of a character string, the application 301 executes an attribute search by selecting a search condition from any one of a complete word search, a partial word search, a prefix search or a suffix search.

For example, when the attribute item value is a date that includes hour and minute information, the application 301 executes an attribute search using a condition of matching up to year, month and day. According to the fourth exemplary embodiment, even when the attribute item value is an extremely precise value, the probability of acquisition of a document file as a search result is enhanced.

That is to say, when the application 301 determines that a drag and drop operation has been executed, a condition determined based on the type of attribute information is used to execute a search of the plurality of electronic documents stored in the electronic document storage unit associated with the drop destination for electronic documents that include the attribute corresponding to the dragged attribute information.

Next, a fifth exemplary embodiment will be described. After the document management apparatus in the fifth exemplary embodiment acquires the electronic document storage unit in step S6 in FIG. 7, the search pane 501 as illustrated in FIG. 5 is displayed prior to execution of the attribute search. The application 301 displays the search pane 501 in a state in which the search condition format related to the combination of the attribute item and the attribute item value acquired in step S3 in FIG. 7 are inputted. When a user inputs an additional search condition format on the search pane 501, the application 301 executes an attribute search using the entire search condition format including the additional search condition format.

In other words, in the fifth exemplary embodiment, when it is determined that a drag and drop operation has been executed (YES in S5 in FIG. 7), the application 301 displays the search screen setting the search format based on the dragged attribute information, and prompts a user to input the additional search format on the search screen. Thereafter, the application 301 uses the entire search format including the addition search format to search for an electronic document in the plurality of electronic documents stored in the electronic document storage unit associated with the drop destination. According to the document management apparatus in the fifth exemplary embodiment, prior to execution of an attribute search, the user can update the search conditions.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer, for example, via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-253535 filed Nov. 12, 2010, which is hereby incorporated by reference herein in its entirety.

What is claimed is:

1. A document management apparatus comprising:
a display unit configured to display on a display screen a plurality of storage units that store a plurality of electronic documents and a plurality of attribute information related to an electronic document selected by a user;
a determination unit configured to determine whether a drag and drop operation has been executed in which attribute information that has been dragged from the plurality of attribute information displayed on the display screen has been dropped into any of the plurality of storage units displayed on the display screen;
a search unit configured to search the plurality of electronic documents stored in the storage unit associated with the drop destination for an electronic document having the attribute corresponding to the dragged attribute information, when the determination unit determines that a drag and drop operation has been executed; and
an output unit configured to output information related to the electronic documents searched by the search unit as a search result.

2. The document management apparatus according to claim 1, wherein the attribute information includes an attribute item and an attribute item value.

3. The document management apparatus according to claim 1, wherein, when the attribute information that is subject to the drag and drop operation is a plurality of types of attribute information, the search unit uses the plurality of types of attribute information subject to the drag and drop operation to search for the electronic document in the plurality of electronic documents stored in the storage unit associated with the drop destination.

4. The document management apparatus according to claim 1, wherein, when the storage unit associated with the drop destination is a storage unit that stores an electronic document having the dropped attribute information and the attribute information subject to the drag and drop operation is determined to be unique to the drop destination storage unit, the output unit outputs the electronic document selected by a user corresponding to the plurality of attribute information displayed by the display unit as a search result without performing a search process by the search unit.

5. The document management apparatus according to claim 1, wherein, when the determination unit determines that a drag and drop operation has been executed, the search unit uses the condition defined based on the type of the dragged attribute information to search for an electronic document having an attribute corresponding to the dragged attribute information in the plurality of electronic documents stored in the storage unit associated with the drop destination.

6. The document management apparatus according to claim 1, wherein, when the determination unit determines that a drag and drop operation has been executed, the search unit displays a search screen that sets a search format based on the dragged attribute information and a user is prompted to input an additional search format on the search screen, and then the search unit uses an entire search format including the additional search format to search for an electronic document from the plurality of electronic documents stored in the storage unit associated with the drop destination.

7. The document management apparatus according to claim 1, wherein the display screen displayed by the display unit is configured by a navigation pane configured to display the plurality of storage units storing the plurality of electronic documents, a file list pane configured to display a plurality of electronic documents stored in the storage units selected by a user from the plurality of storage units displayed on the navigation pane, and a property pane configured to display a plurality of attribute information related to the electronic document selected by a user from the plurality of electronic documents displayed on the file list pane.

8. A method for controlling a document management apparatus, the method comprising:
displaying on a display screen a plurality of storage units that store a plurality of electronic documents and a plurality of attribute information related to an electronic document selected by a user;
determining, in a determining step, whether a drag and drop operation has been executed in which attribute information that has been dragged from the plurality of attribute information displayed on the display screen has been dropped into any of the plurality of storage units displayed on the display screen;
searching, in a searching step, the plurality of electronic documents stored in the storage unit associated with the drop destination for an electronic document having the attribute corresponding to the dragged attribute information, when it is determined in a determining step that a drag and drop operation has been executed; and
outputting information related to the electronic documents searched in the searching step as a search result.

9. A computer readable storage medium storing a computer program, wherein the computer program causes the computer to functions as a document management apparatus which comprises:
a display unit configured to display a plurality of storage units that store a plurality of electronic documents and a plurality of attribute information related to an electronic document selected by a user;
a determination unit configured to determine whether a drag and drop operation has been executed in which attribute information that has been dragged from the plurality of attribute information displayed on the display screen has been dropped into any of the plurality of storage units displayed on the display screen;
a search unit configured to search the plurality of electronic documents stored in the storage unit associated with the drop destination for an electronic document having the attribute corresponding to the dragged attribute information, when the determination unit determines that a drag and drop operation has been executed; and
an output unit configured to output information related to the electronic documents searched by the search unit as a search result.
